(19) United States
(12) Patent Application Publication
(10) Pub. No.: US 2024/0080125 A1
(43) Pub. Date: Mar. 7, 2024

(54) METHOD AND APPARATUS FOR DETECTING SIGNAL JAMMING IN A CELLULAR COMMUNICATION NETWORK

(71) Applicant: Telefonaktiebolaget LM Ericsson (publ), Stockholm (SE)

(72) Inventor: Ke Zhong, Beijing (CN)

(21) Appl. No.: 18/272,373

(22) PCT Filed: Jan. 18, 2021
(86) PCT No.: PCT/CN2021/072435

§ 371 Date: Jul. 14, 2023

(51) Int. Cl. H04K 3/00

(52) U.S. Cl. CPC H04K 3/22; H04K 2203/16

(57) ABSTRACT

The present invention generally relates to wireless communication technology. More particularly, the present invention relates to a method for detecting signal jamming in a cellular communication network. The present invention also relates to apparatus and computer program product adapted for the same purpose. According to one embodiment of the present invention, a method for detecting signal jamming in a cellular communication network comprises the following steps: determining correlation between reference signals received at a plurality of antennas in a cell; and determining whether the cell is in a jamming-suspicious state on the basis of the correlation and consistency between a traffic load and non-zero power signal strength in the cell.

### TECHNICAL FIELD

The present invention generally relates to wireless communication technology. More particularly, the present invention relates to a method for detecting signal jamming in a cellular communication network. The present invention also relates to apparatus and computer program product adapted for the same purpose.

### BACKGROUND

A recurring point of concern from industries, particularly those with mission critical type applications, is that of intentional and targeted jamming. Jamming will obviously degrade performance of a cellular communication system. Typically, the more the jamming power is, the worse the system performance will become. These industries are aware of the existence of affordable commercial jammers of cellular signals (and other radio signals such as GPS and Wi-Fi), some because they have fallen victim to targeted Wi-Fi jamming attacks that have resulted in disruption in production environments incurring economic loss.

Usually, jammers is one of interference sources in real scenarios. To decide whether a frequency band is suffering from interference/jamming or not, an auxiliary equipment like a spectrum analyzer can be used. For example, a human operator scans radio spectrum with a spectrum analyzer at a location which is suspicious of being jammed. In general, however, the jamming behavior is dependent on the characteristics of a jammer, and thus it is difficult to detect signal jamming without knowledge on the jammer. On the other hand, unlike in remote interference management (RIM) where reference signals (RS), which are well specified in 3GPP specification, are used for detecting the existence of interference, typically, knowledge on the characteristics of a jammer is unavailable.

### SUMMARY OF THE INVENTION

The present disclosure describes effective and efficient solutions to handle the above issues. In one or more embodiments of the present invention, it detects the signal jamming based on jamming/interference plus noise power from uplink or downlink reference signals, e.g., ones in pilot symbols or zero-power data signals. In the detection, consistency between a traffic load and non-zero power signal strength in a cell is further introduced to improve the detection performance.

According to one embodiment, a method for detecting signal jamming in a cellular communication network comprises the following steps:
determining correlation between reference signals received at a plurality of antennas in a cell; and
determining whether the cell is in a jamming-suspicious state on the basis of the correlation and consistency between a traffic load and non-zero power signal strength in the cell.

According to another embodiment, an apparatus for detecting signal jamming in a cellular communication network comprises:
a storage device configured to store a computer program comprising computer instructions; and
a processor coupled to the storage device and configured to execute the computer instructions to:
   determine correlation between reference signals received at a plurality of antennas in a cell; and
   determine whether the cell is in a jamming-suspicious state on the basis of the correlation and consistency between a traffic load and non-zero power signal strength in the cell.

According to still another embodiment, a computer program product for detecting signal jamming in a cellular communication network is embodied in a computer readable storage medium and comprises computer instructions for carrying out the steps of the method according to the above and other embodiments.

In one or more embodiments of the present invention, knowledge on jammer characteristics are unnecessary in jamming detection. Additionally, the uplink or downlink reference signals are used widely and thus the present invention is applicable to a variety of cellular communication systems.

### BRIEF DESCRIPTION OF THE DRAWINGS

The foregoing and other objects, features, and advantages of the invention would be apparent from the following more particular description of preferred embodiments as illustrated in the accompanying drawings in which:

FIG. 1 schematically illustrates a flowchart of a method for detecting signal jamming in a cellular communication network according to one exemplary embodiment of the present invention.

FIG. 2 schematically illustrates a flowchart of a method for detecting signal jamming in a cellular communication network according to another exemplary embodiment of the present invention.

FIG. 3 schematically illustrates a flowchart of a method for detecting signal jamming in a cellular communication network according to another exemplary embodiment of the present invention.

FIG. 4 is a block diagram illustrating an apparatus detecting signal jamming in a cellular communication network according to another exemplary embodiment of the present invention.

FIG. 5 illustrates an example of signal jamming where a cell is in a full-band jamming state.

FIGS. 6a and 6b illustrate FBJ detection performance per slot, i.e., Missed detection rate versus SNR achieved by the embodiments of the present disclosure.

FIGS. 7a and 7b illustrate FBJ detection performance per frame, i.e., Missed detection rate versus SNR achieved by the embodiments of the present disclosure.

FIG. 8 illustrates comparison between the FBJ detection per slot and the FBJ detection per frame.

FIG. 9 illustrates an example of signal jamming where a cell is in a partial-band jamming state.

FIGS. 10a and 10b illustrate PBJ detection performance per frame, i.e., Missed detection rate versus SNR achieved by the embodiments of the present disclosure.

FIG. 11 illustrates FBJ detection performance per slot, i.e., False alarm rate versus SNR achieved by the embodiments of the present disclosure.

FIG. 12 illustrates FBJ detection performance per frame, i.e., False alarm rate versus SNR achieved by the embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, the term “terminal device” may be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

Throughout the description, the term “jamming” is used to describe the deliberate or intentional use of radio noise or signals in an attempt to disrupt communication, and the term “interference” is used to describe both of intentional and unintentional forms of disruption.

A radio signal at receiving side may result from a combination of several sources, e.g., a transmitter, a jammer and other interference source(s). The inventor of the present invention recognizes that for correlation between reference signals received at an antenna array or a group of antennas, it exhibits different levels when a cell is in a jamming state and a non-jamming state. According to one ore more embodiments of the present invention, a criteria associated with the correlation (referred to as “correlation-basis criteria” hereinafter) is utilized in jamming detection. In one or more non-restrictive examples, the correlation can be measured with an indicator from an estimated interference plus noise covariance matrix for reference signals corresponding to a group of subcarriers, each element of which represents the cross-correlation coefficient between two of the reference signals or the self-correlation coefficient for one of the reference signals; the indicator may be selected as a ratio between a determinant of the covariance matrix and a product of main diagonal entries of the covariance matrix.

Furthermore, to improve detection performance, e.g., missed detection rate and false alarm rate, an additional criteria (referred to as “consistency-basis criteria” hereinafter) is introduced. To be specific, if it determines from the correlation that jamming may occur in a cell, consistency check is made between a traffic load and non-zero power signal strength in the cell. For example, if an observed packet data rate (PDR) in the cell is at a low level and an observed non-zero power signal (e.g., signal for carrying traffic data) strength in the cell is at a high level, it suggests that inconsistency exists and thus the cell is interfered by a jammer or other source(s), i.e., the cell is in a jamming-suspicious state.

It should be noted that the above correlation-basis and consistency-basis criterion are applicable to both uplink and downlink reference signals, i.e., reference signals transmitted via an uplink channel or a downlink channel. In one or more non-restrictive examples, the reference signals may be signals in one or more pilot symbols or zero-power data signals, which are transmitted from a terminal device, or a base station.

In one or more non-restrictive examples, the traffic load may be measured by at least one selected from a group consisting of a Packet Delivery Ratio (PDR), a Block Error Rate (BLER), a Bit Error Rate (BER), throughput, a retransmission rate, a Reference Signal Received Power (RSRP), a Reference Signal Received Quality (RSRQ), a Received Signal Strength Indicator (RSSI) in a cell.

For a cell in the jamming-suspicious state, it may be desirable to distinguish between the signal jamming and other interference(s), e.g., inter-cell interference (ICI) and intra-cell interference. According to one or more embodiments of the present invention, this can be achieved by utilizing characteristics over frequency and time of the reference signals. In one or more non-restrictive examples, the characteristics over frequency can be characterized or represented as a power level deviation among the reference signals corresponding to a group of subcarriers, and the characteristics over time can be characterized or represented as a power level deviation from a normal power level, e.g., one when the traffic load is low in the cell. With the combination of these two deviations, it can determine which state the cell is in, e.g., jamming only, jamming+ICI (or intra-cell interference), or ICI (or intra-cell interference) only.

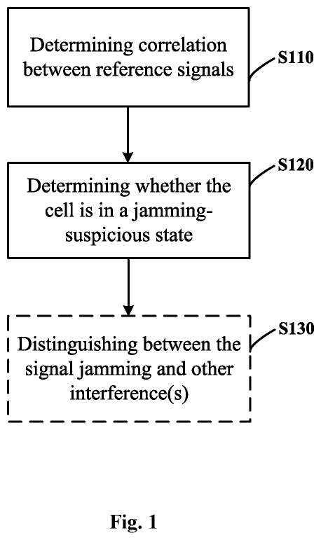

FIG. 1 schematically illustrates a flowchart of a method for detecting signal jamming in a cellular communication network according to one exemplary embodiment of the present invention.

With reference to FIG. 1, at step S110, correlation between reference signals received at a plurality of antennas in a cell is determined.

Then, at step S120, it determines whether the cell is in a jamming-suspicious state on the basis of the correlation-basis and consistency-basis criterion.

Optionally, the process proceeds to step S130 where it distinguishes between the signal jamming and other interference(s) on the basis of characteristics over frequency and time of the reference signals if the cell is in the jamming-suspicious state.

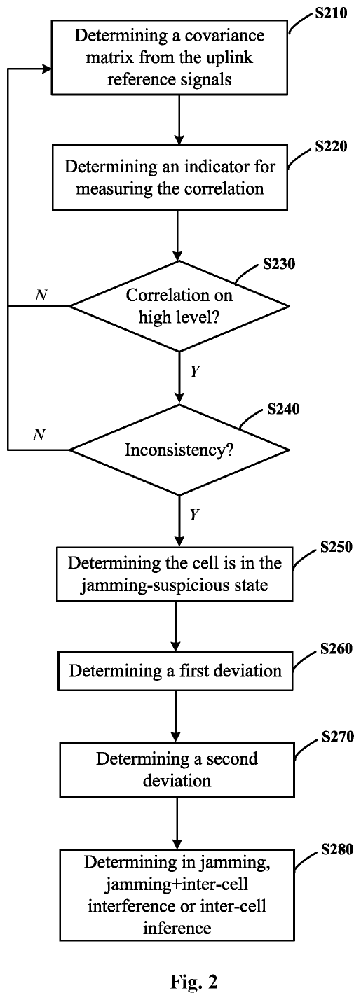

FIG. 2 schematically illustrates a flowchart of a method for detecting signal jamming in a cellular communication network according to another exemplary embodiment of the present invention.

With reference to FIG. 2, at step S210, a covariance matrix for describing estimated interference plus noise level for reference signals corresponding to a group of subcarriers in a cell is determined or generated. In one illustrative and non-restrictive example, the covariance matrix describes the estimated interference plus noise level during a time interval, e.g., one or more Transmission Time Intervals (TTIs). For a single one TTI, the covariance matrix may be represented in the following form:

$${Q}_{n} ( {k}_{Q} ) = {\sum }_{{l}_{RS} = 0}^{{N}_{RS} - 1} {\sum }_{k = 0}^{{N}_{k}^{Q} - 1} E ( k , {l}_{RS} ) {E ( k , {l}_{RS} )}^{H} \qquad ( 1 )$$

$$E ( k , {l}_{RS} ) = [ \begin{matrix}E ( k , {l}_{RS} , 0 ) \\ ⋮ \\ E ( k , {l}_{RS} , {N}_{b} - 1 )\end{matrix} ] \qquad ( 2 )$$

$$E ( k , {l}_{RS} , b ) = Y ( k , b , {l}_{RS} ) - H ( k , b , {l}_{RS} ) R ( k , b , {l}_{RS} ) \qquad ( 3 )$$

where n refers to TTI index, Qₙ(k_{Q}) refers to the covariance matrix for the n^{th} TTI, K_{Q} refers to covariance group index or index for the group of the subcarriers, (.)^{H} refers to Hermitian operation, N_{RS} refers to the number of pilot symbols, Nₖ^{Q} refers to the number of subcarriers per covariance group, k refers to subcarrier index, l_{RS} refers to pilot symbol index, Y(k,b,l_{RS}) refers to received frequency domain signal at subcarrier k, pilot symbol l_{RS}, for beam b, H(k,b,l_{RS}) refers to channel estimate at subcarrier k, pilot symbol l_{RS}, for beam b, and R(k,b,l_{RS}) refers to the pilot symbol at subcarrier k, pilot symbol l_{RS}, for beam b.

For multiple TTIs, the covariance matrix is an average over the multiple TTIs and may be represented in the following form:

$${Q}_{avg , n} ( {k}_{Q} ) = \frac{1}{N} {\sum }_{i = 1}^{N} {Q}_{n - i} ( {K}_{Q} ) \qquad ( 4 )$$

where N refers to the number of TTIs consisting of the time interval, n refers to TTI index, Q_{avg,n}(k_{Q}) refers to the covariance matrix for the n^{th} TTI as an average over the previous N TTIs, K_{Q} refers to covariance group index or index for the group of the subcarriers, and Qₙ₋ᵢ(k_{Q}) refers to the covariance matrix for the (n−i)^{th} TTI which can be obtained by using formulas (1)-(3).

Then at step S220, an indicator for measuring the correlation or a correlation indicator is determined from the covariance matrix. For the single one TTI, the correlation indicator may be represented in the following form:

$${a}_{n} ( {K}_{Q} ) = \frac{\vert {Q}_{n} ( {K}_{Q} ) \vert}{{Π}_{r = 0}^{N r - 1} {Q}_{n} ( {K}_{Q} , r , r )} \qquad ( 5 )$$

where n refers to TTI index, aₙ(k_{Q}) refers to the correlation indicator for the n^{th} TTI, |Qₙ(k_{Q})| refers to a determinant of the covariance matrix Qₙ(k_{Q}), which can be obtained by using formulas (1)-(3), K_{Q} refers to covariance group index or index for the group of the subcarriers, Qₙ(k_{Q},r,r) refers to the r^{th} main diagonal entry of the covariance matrix Qₙ(k_{Q}).

For multiple TTIs, the correlation indicator may be represented in the following form:

$${a}_{n} ( {K}_{Q} ) = \frac{\vert {Q}_{avg , n} ( {K}_{Q} ) \vert}{{Π}_{r = 0}^{N r - 1} {Q}_{aνg , n} ( {K}_{Q} , r , r )} \qquad ( 6 a )$$

where n refers to TTI index, and aₙ(k_{Q}) refers to the correlation indicator for the n^{th} TTI, |Q_{avg,n}(k_{Q})| refers to a determinant of the covariance matrix Q_{avg,n}(k_{Q}), which can be obtained by using formulas (1)-(4), K_{Q} refers to covariance group index or index for the group of the subcarriers, Q_{avg,n}(k_{Q},r,r) refers to the r^{th} main diagonal entry of the covariance matrix Q_{avg,n}(k_{Q}).

Alternatively, the correlation indicator may be represented in the following form:

$${a}_{avg , n} ( {K}_{Q} ) = \frac{1}{N} {\sum }_{i - 1}^{N} {a}_{n - i} ( {K}_{Q} ) \\ \qquad ( 6 b )$$

where N refers to the number of TTIs consisting of the time interval, n refers to TTI index, a_{avg,n}(k_{Q}) refers to the correlation indicator for the n^{th} TTI as an average over the previous N TTIs, K_{Q} refers to covariance group index or index for the group of the subcarriers, and aₙ₋ᵢ(k_{Q}) can be obtained by using formulas (6a).

The flowchart then proceeds to step S230 where a correlation-basis criteria is carried out to judge whether the correlation level is at a high level. If at a high level, the flowchart proceeds to step S240; otherwise, it returns step S210 for the next TTI. In one illustrative and non-restrictive example, the correlation-basis criteria may be represented as follows:

$$\{ \begin{matrix}The correlation is high enough & \begin{matrix}if {a}_{n} ( {K}_{Q} ) < {T}_{IRC} ( {N}_{b} ) or \\ {a}_{avg , n} ( {K}_{Q} ) < {T}_{IRC} ( {N}_{b} )\end{matrix} \\ The correlation is low & \begin{matrix}if {a}_{n} ( {K}_{Q} ) \geq {T}_{IRC} ( {N}_{b} ) or \\ {a}_{avg , n} ( {K}_{Q} ) \geq {T}_{IRC} ( {N}_{b} )\end{matrix}\end{matrix}$$

where Nᵣ refers to the number of receiving antennas, N_{b} refers to the number of beams, K_{Q} refers to covariance group index, and T_{IRC}(N_{b}) refers to a predetermined threshold. As an illustrative example, for Physical Uplink Shared Channel (PUSCH), the threshold may be set as follows.

TABLE I

| N_{b} | N_{RB}^{Q}(N_{b}) | T_{IRC}(N_{b}) |
|---|---|---|
| 1 | 1 | — |
| 2 | 1 | 0.7 |
| 4 | 1 | 0.3 |
| 8 | 2 | 0.15 |
| 16 | 4 | 0.033 |

where N_{RB}^{Q}(N_{b}) refers to the number of resource blocks per covariance group.

At step S240, based on a consistency-basis criteria, a consistency check is carried out between the traffic load and the non-zero power signal strength in the cell. If inconsistency exists, the flowchart proceeds to step S250; otherwise, it returns step S210.

In one illustrative and non-restrictive example, the consistency-basis criteria may be represented as follows:

TABLE II

| | Observed non-zero power | |
|---|---|---|
| Observed PDR | signal strength | Judgement |
| Low | Low | consistency |
| Low | High | inconsistency |

According to the criteria as defined in Table II, if an observed packet data rate (PDR) in the cell is at a low level and an observed non-zero power signal strength in the cell is at a high level, it determines that inconsistency exists.

It should be noted that the traffic load may also be measured by other parameters, e.g., BLER, BER, throughput, retransmission rate, RSRP, RSRQ, RSSI.

At step S250, it determines that the cell is in a jamming-suspicious state.

As noted above, it may be desirable to distinguish between the signal jamming and other interference(s), e.g., inter-cell interference (ICI) and intra-cell interference upon determining that a cell is in the jamming-suspicious state. To this end, the following steps S260 to S280 are carried out to distinguish between the signal jamming and inter-cell PUSCH interference.

At step S260, a first deviation Δ₁ is determined to describe the characteristics over frequency among reference signals with different frequencies during a time interval, e.g., one ore more TTIs. In an illustrative and non-restrictive example, the first deviation may be represented as a power level deviation among the reference signals corresponding to multiple covariance groups, e.g., a standard deviation for power levels of the residual signals in pilot symbols for multiple covariance groups or power levels of the uplink zero-power signals for multiple covariance groups during one or more TTIs.

The flowchart proceeds to step S270 where a second deviation Δ₂ is determined to describe the characteristics over time for one or more power levels of reference signal during a time interval, e.g., one ore more TTIs. In an illustrative and non-restrictive example, the second deviation may be represented as a deviation from a normal power level, e.g., during a period where the traffic load in the cell is low, in terms of one or more power levels for residual signals in pilot symbols or uplink zero-power signals during one ore more TTIs.

Then, at step S280, based on the combination of these two deviations, it determines which state the cell is in, e.g., jamming state (i.e., jamming only), jamming+ICI state, or ICI state (i.e., ICI only). In an illustrative and non-restrictive example, a relationship between the combination and the state as determined is described with reference to Table III as below.

TABLE III

| | Jamming | Jamming + ICI | ICI only |
|---|---|---|---|
| First deviation Δ₁ | Small | Large | Large |
| Second deviation Δ₂ | Large | Large | Small |

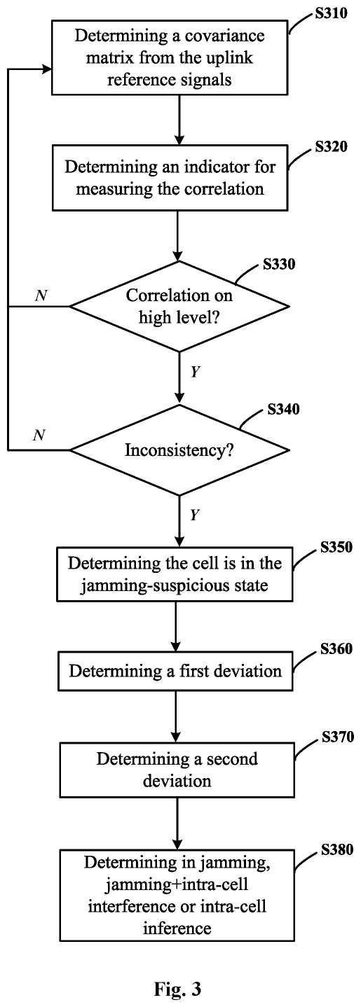

FIG. 3 schematically illustrates a flowchart of a method for detecting signal jamming in a cellular communication network according to another exemplary embodiment of the present invention.

With reference to FIG. 3, at step S310, a covariance matrix for describing estimated interference plus noise level for reference signals corresponding to a group of subcarriers in a cell is determined or generated in a manner similar to step S210.

Then at step S320, an indicator for measuring the correlation or a correlation indicator is determined from the covariance matrix in a manner similar to step 220.

The flowchart then proceeds to step S330 where a correlation-basis criteria is carried out to judge whether the correlation level is at a high level. If at a high level, the flowchart proceeds to step S340; otherwise, it returns step S310 for the next TTI. In one illustrative and non-restrictive example, the correlation-basis criteria as described with reference to FIG. 2 is available.

At step S340, based on a consistency-basis criteria, a consistency check is carried out between the traffic load and the non-zero power signal strength in the cell. If inconsistency exists, the flowchart proceeds to step S350; otherwise, it returns step S310. In one illustrative and non-restrictive example, the consistency-basis criteria as described with reference to FIG. 2 is available.

At step S350, it determines that the cell is in a jamming-suspicious state.

The following steps S360 to S380 are carried out to distinguish between the signal jamming and intra-cell PRACH interference.

At step S360, a first deviation Δ′₁ is determined to describe the characteristics over frequency among reference signals with different frequencies during a time interval, e.g., one ore more TTIs. In an illustrative and non-restrictive example, the first deviation may be represented as a standard deviation among power levels of Physical Random Access Channel (PRACH) signals for a plurality of Physical Resource Blocks (PRBs).

The flowchart proceeds to step S370 where a second deviation is determined to describe the characteristics over time for one or more power levels of reference signal during a time interval, e.g., one ore more TTIs. In an illustrative and non-restrictive example, the second deviation may be represented as a deviation from a normal power level, e.g., during a period where the traffic load in the cell is low, in terms of one or more power levels of PRACH signals for a plurality of Physical Resource Blocks PRBs.

Then, at step S380, based on the combination of these two deviations, it determines which state the cell is in, e.g., jamming state (i.e., jamming only), jamming+intra-cell interference state, or intra-cell interference state (i.e., intra-cell interference only). In an illustrative and non-restrictive example, a relationship between the combination and the state as determined is described with reference to Table IV as below.

TABLE IV

| | | Jamming + intra- | intra-cell |
|---|---|---|---|
| | Jamming | cell interference | interference only |
| First deviation Δ′₁ | Small | Large | Large |
| Second deviation Δ′₂ | Large | Large | Small |

Advantageously, a function for signal jamming detection begins once RRC connection has been setup (e.g., in Physical Uplink Shared Channel (PUSCH) phase), and is enabled during the whole system operation. Although the detection can be performed on both Physical Random Access Channel (PRACH) and PUSCH, it is preferable to perform the detection during PUSCH phase as PRACH transmission is usually short and random. Once the RRC connection is setup, more stable PUSCH data are available for signal jammer detection.

It should be noted the signal jamming detection framework described above can be based on jamming/interference plus noise power in pilot symbols (for example in uplink DMRS, SRS, PTRS etc.) or in TDD UpPTS.

For uplink SU-MIMO, the jamming/interference plus noise power in pilot symbol can be obtained by using the estimated residual signal on known pilot symbols. For uplink MU-MIMO, the jamming/interference plus noise power in pilot symbol can be obtained by using the signal on known orthogonal pilot symbols directly.

In a noise-limited environment where no jamming exists or jamming power is small, MRC receiver slightly outperforms IRC receiver. On the other hand, in an interference-limited environment where jamming power is large, IRC receiver will gradually outperform MRC receiver and the performance gain is significant when jamming power is large.

FIG. 4 is a block diagram illustrating an apparatus detecting signal jamming in a cellular communication network according to another exemplary embodiment of the present invention.

With reference to FIG. 4, the apparatus 40 comprises a storage device 410 and a processor 420 coupled to the storage device 410. The storage device 410 is configured to store a computer program 430 comprising computer instructions. The processor 420 is configured to execute the computer instructions to perform some or all of the method steps as shown in FIGS. 1-3.

It should be noted that the aforesaid embodiments are applicable to both uplink and downlink reference signals, i.e., reference signals transmitted via an uplink channel or a downlink channel.

FIG. 5 illustrates an example of signal jamming where a cell is in a full-band jamming (FBJ) state. As shown in FIG. 5, in the absence of jamming, the averaged IPN per PRB is around −117˜−118 dBm, and for full-band jamming, the IPN level increases substantially for all jammed PRBs. IPN for AAS is larger than IPN for non-AAS because of beamforming gain.

With the embodiments as described above, the detection for FBJ may be performed per TTI (i.e., 1 slot and thus also referred to “FBJ detection per slot” hereinafter) or per frame (i.e., per 20 slots assuming 30 kHz subcarrier spacing and also referred to “FBJ detection per frame” hereinafter).

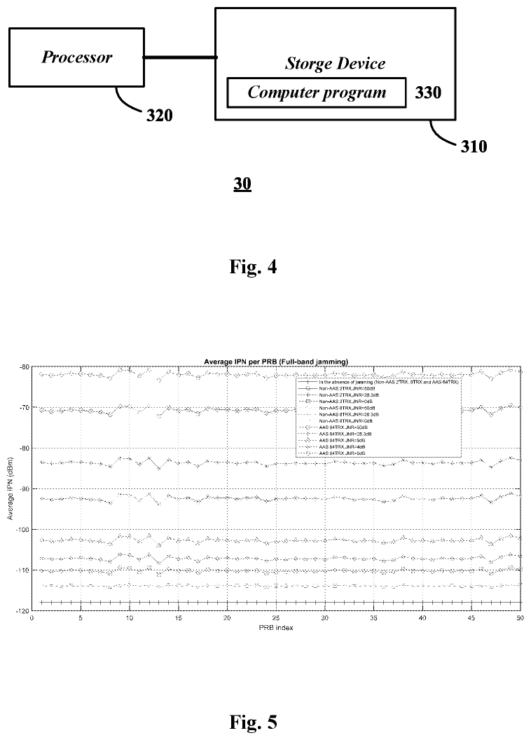

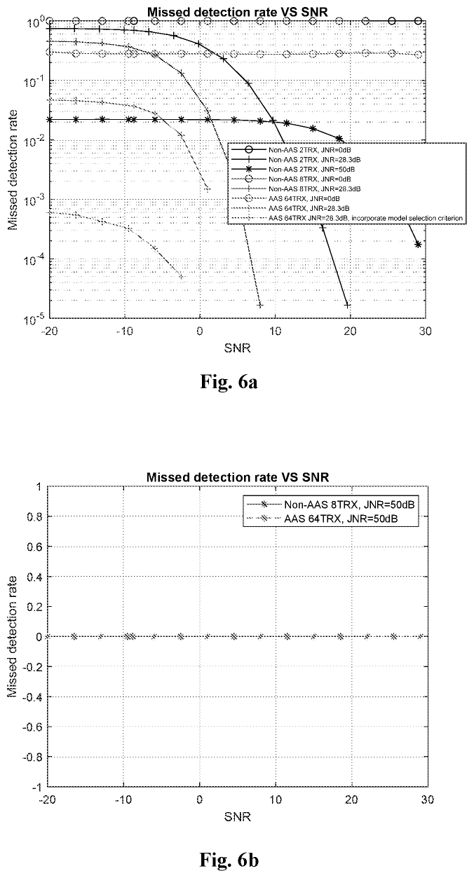

FIGS. 6a and 6b illustrate FBJ detection performance per slot, i.e., Missed detection rate versus SNR achieved by the embodiments as described above.

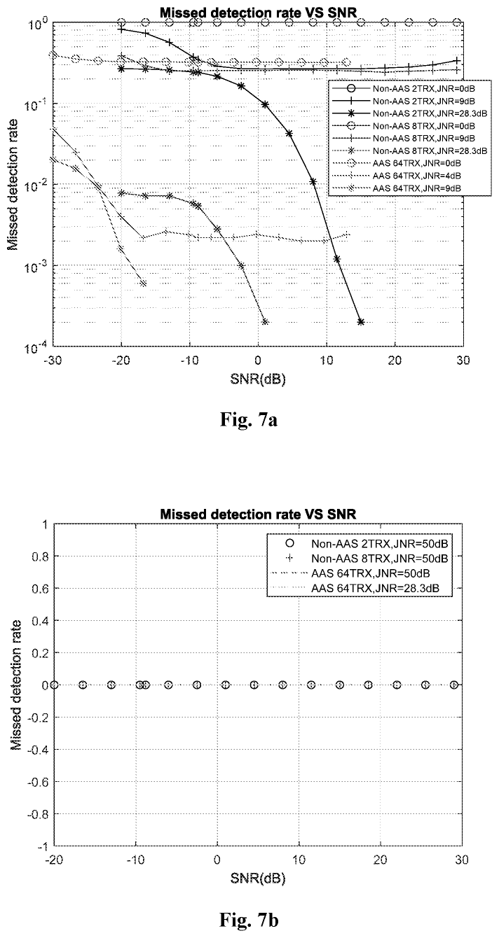

FIGS. 7a and 7b illustrate FBJ detection performance per frame, i.e., Missed detection rate versus SNR achieved by the embodiments as described above.

As can be seen from FIGS. 6a, 6b, 7a and 7b, compared to the FBJ detection per slot, the FBJ detection per frame can improve the detection performance significantly.

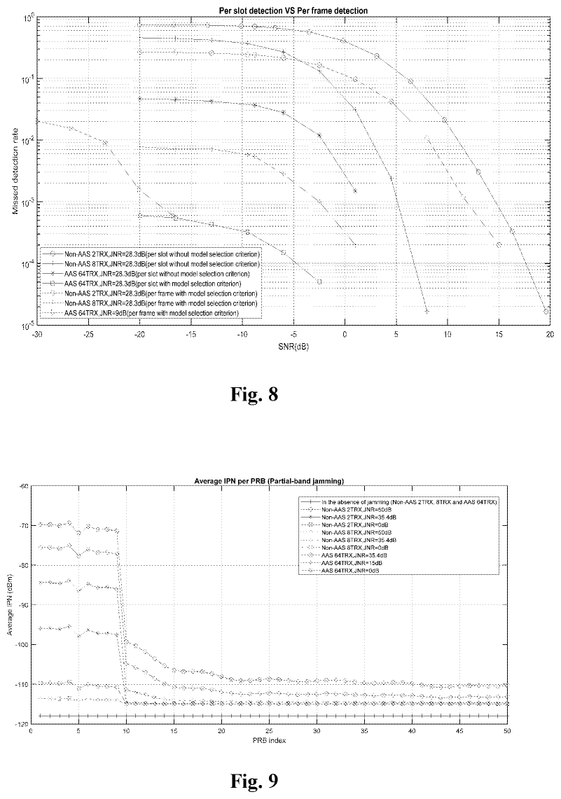

FIG. 8 illustrates comparison between the FBJ detection per slot and the FBJ detection per frame.

With 1% Pmiss of the goal, for non-AAS 2TRX, the FBJ detection per frame can improve about 3 dB compared to the FBJ detection per slot, for non-AAS 8TRX, the FBJ detection per frame can improve about 23 dB compared to the FBJ detection per slot, for AAS 64TRX, the FBJ detection per frame can improve performance compared to the FBJ detection per slot.

FIG. 9 illustrates an example of signal jamming where a cell is in a partial-band jamming (PBJ) state. As shown in FIG. 9, for partial-band jamming, the IPN level of the first ten PRBs, which are the jammed PRBs, increases substantially. IPN for AAS is larger than IPN for non-AAS because of beamforming gain.

With the embodiments as described above, the detection for PBJ may be performed per TTI (i.e., 1 slot and thus also referred to “PBJ detection per slot” hereinafter) or per frame (i.e., per 20 slots assuming 30 kHz subcarrier spacing and also referred to “PBJ detection per frame” hereinafter).

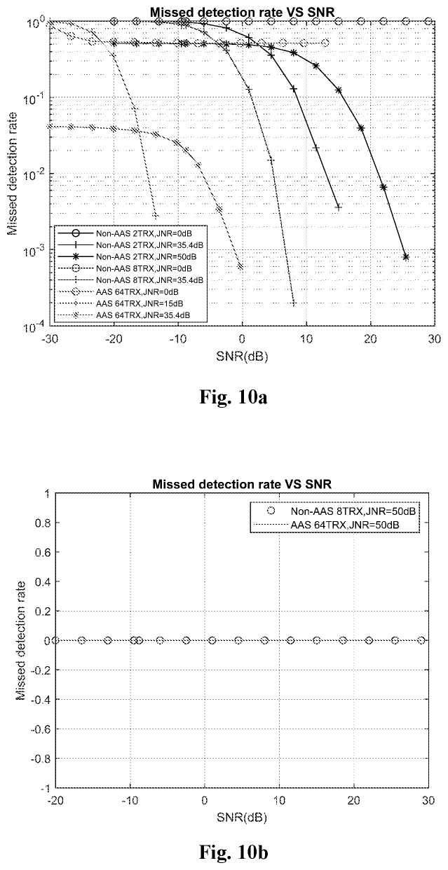

FIGS. 10a and 10b illustrate PBJ detection performance per frame, i.e., Missed detection rate versus SNR achieved by the embodiments as described above.

As can be seen from FIGS. 10a and 10b, the performance is also improved in PBJ.

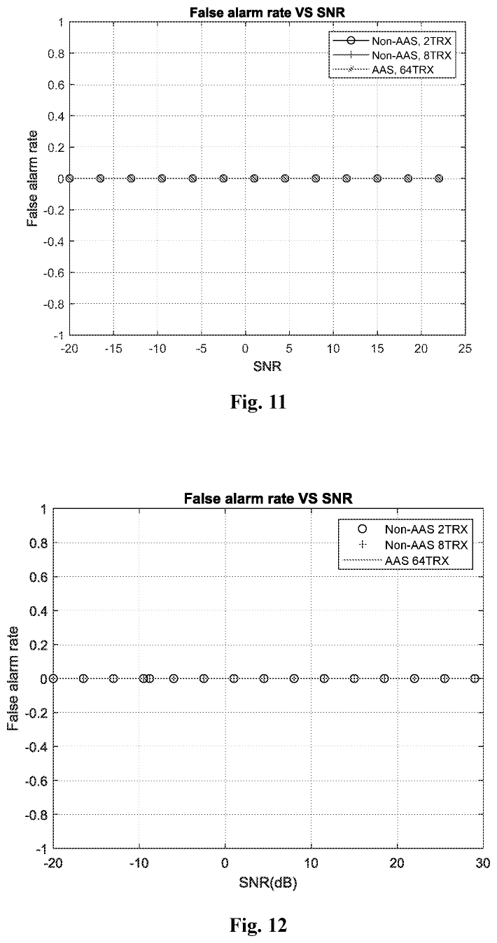

FIG. 11 illustrates FBJ detection performance per slot, i.e., False alarm rate versus SNR achieved by the embodiments as described above.

As can be seen from FIG. 11, zero false alarm probability can be achieved in the detection.

FIG. 12 illustrates FBJ detection performance per frame, i.e., False alarm rate versus SNR achieved by the embodiments as described above.

As can be seen from FIG. 12, zero false alarm probability can be also achieved in the detection.

It should be noted that the aforesaid embodiments are illustrative of this invention instead of restricting this invention, substitute embodiments may be designed by those skilled in the art without departing from the scope of the claims enclosed. The wordings such as “include”, “including”, “comprise” and “comprising” do not exclude elements or steps which are present but not listed in the description and the claims. It also shall be noted that as used herein and in the appended claims, the singular forms “a”, “an”, and “the” include plural referents unless the context clearly dictates otherwise. This invention can be achieved by means of hardware including several different elements or by means of a suitably programmed computer. In the unit claims that list several means, several ones among these means can be specifically embodied in the same hardware item. The use of such words as first, second, third does not represent any order, which can be simply explained as names. While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the invention, and it is to be understood that modifications and variations may be resorted to without departing from the spirit and scope of the invention as those skilled in the art readily understand. Such modifications and variations are considered to be within the scope of the invention and the appended claims. The protection scope of the invention is defined by the accompanying claims.

1. A method for detecting signal jamming in a cellular communication network, be characterized by comprising:
determining correlation between reference signals received at a plurality of antennas in a cell; and
determining whether the cell is in a jamming-suspicious state on the basis of the correlation and consistency between a traffic load and non-zero power signal strength in the cell.

2. The method according to claim 1, further comprising:
if in the jamming-suspicious state, distinguishing between the signal jamming and other interference(s) on the basis of characteristics over frequency and time of the reference signals.

3. The method according to claim 1, wherein the reference signals are transmitted via an uplink channel or a downlink channel.

4. The method according to claim 1, wherein the reference signals are signals in one or more pilot symbols or zero-power data signals transmitted from a terminal device, or a base station.

5. The method according to claim 4, wherein the step of determining the correlation comprising:
determining a covariance matrix for a group of subcarriers during one or more Transmission Time Intervals (TTIs) from the reference signals; and
determining an indicator for measuring the correlation from the covariance matrix.

6. The method according to claim 5, wherein the covariance matrix is an average of interference plus noise covariance matrices for the group of subcarriers during two or more TTIs; and/or
wherein the indicator for measuring the correlation is represented as a ratio between a determinant of the covariance matrix and a product of main diagonal entries of the covariance matrix.

7. (canceled)

8. The method according to claim 5, wherein the step of determining the jamming-suspicious state comprising:
comparing the indicator with a predetermined threshold;
performing a consistency check between the traffic load and the non-zero power signal strength in the cell; and
determining the cell is in the jamming-suspicious state if the following conditions are met: 1) the correlation is on a high level; and 2) an inconsistency exists between the traffic load and the non-zero power signal strength in the cell.

9. The method according to claim 1, wherein the traffic load is measured by at least one selected from a group consisting of a Packet Delivery Ratio (PDR), a Block Error Rate (BLER), a Bit Error Rate (BER), throughput, a retransmission rate, a Reference Signal Received Power (RSRP), a Reference Signal Received Quality (RSRQ), a Received Signal Strength Indicator (RSSI) in the cell.

10. The method according to claim 2, wherein the characteristics over frequency and time are represented as: 1) a first deviation among power levels of residual signals in pilot symbols or zero-power signals for a plurality of groups of subcarriers during one or more TTIs; and 2) a second deviation for at least one of the power levels during the one or more TTIs from a normal power level during a period where the traffic load in the cell is low.

11. The method according to claim 10, wherein the step of distinguishing between the signal jamming and the other interference(s) comprising:
determining the first deviation and the second deviation; and
determining the cell is in a jamming state if the first deviation is small and the second deviation is large, the cell is in an inter-cell interference state if the first deviation is large and the second deviation is small, and the cell is in a jamming plus inter-cell interference state if the first deviation is large and the second deviation is large.

12. The method according to claim 2, wherein the characteristics over frequency and time are represented as: 1) a first deviation among power levels of Physical Random Access Channel (PRACH) signals for a plurality of Physical Resource Blocks (PRBs); and 2) a second deviation for at least one of the power levels from a normal power level during a period where the traffic load in the cell is low.

13. The method according to claim 12, wherein the step of distinguishing between the signal jamming and the other interference(s) comprising:
determining the first deviation and the second deviation; and
determining the cell is in a jamming state if the first deviation is small and the second deviation is large, the cell is in an intra-cell interference state if the first deviation is large and the second deviation is small, and the cell is in a jamming plus intra-cell interference state if the first deviation is large and the second deviation is large.

14. An apparatus for detecting signal jamming in a cellular communication network, be characterized by comprising:
a storage device configured to store a computer program comprising computer instructions; and
a processor coupled to the storage device and configured to execute the computer instructions to:
determine correlation between reference signals received at a plurality of antennas in a cell; and
determine whether the cell is in a jamming-suspicious state on the basis of the correlation and consistency between a traffic load and non-zero power signal strength in the cell.

15. The apparatus according to claim 14, the processor configured to execute the computer instructions further to:
if in the jamming-suspicious state, distinguish between the signal jamming and other interference(s) on the basis of characteristics over frequency and time of the reference signals.

16. (canceled)

17. The apparatus according to claim 14, wherein the reference signals are signals in one or more pilot symbols or zero-power data signals transmitted from a terminal device or a base station.

18. The apparatus according to claim 17, wherein the processor configured to execute the computer instructions to determine the correlation by:
determining a covariance matrix for a group of subcarriers during one or more Transmission Time Intervals (TTIs) from the reference signals; and
determining an indicator for measuring the correlation from the covariance matrix.

19. The apparatus according to claim 18, wherein the covariance matrix is an average of interference plus noise covariance matrices for the group of subcarriers during two or more TTIs; and/or
wherein the indicator for measuring the correlation is represented as a ratio between a determinant of the covariance matrix and a product of main diagonal entries of the covariance matrix.

20. (canceled)

21. The apparatus according to claim 18, wherein the processor configured to execute the computer instructions to determine the jamming-suspicious state by:
comparing the indicator with a predetermined threshold;
performing a consistency check between the traffic load and the non-zero power signal strength in the cell; and
determining the cell is in the jamming-suspicious state if the following conditions are met: 1) the correlation is on a high level; and 2) an inconsistency exists between the traffic load and the non-zero power signal strength in the cell.

22. (canceled)

23. The apparatus according to claim 15, wherein the characteristics over frequency and time are represented as: 1) a first deviation among power levels of residual signals in pilot symbols or zero-power signals for a plurality of groups of subcarriers during one or more TTIs; and 2) a second deviation for at least one of the power levels during the one or more TTIs from a normal power level during a period where the traffic load in the cell is low; or
wherein the characteristics over frequency and time are represented as: 1) a first deviation among power levels of Physical Random Access Channel (PRACH) signals for a plurality of Physical Resource Blocks (PRBs); and 2) a second deviation for at least one of the power levels from a normal power level during a period where the traffic load in the cell is low.

24-26. (canceled)

27. A computer program product for detecting signal jamming in a cellular communication network, the computer program product being embodied in a computer readable storage medium and comprising computer instructions for carrying out the following steps:
determining correlation between reference signals received at a plurality of antennas in a cell; and
determining whether the cell is in a jamming-suspicious state on the basis of the correlation and consistency between a traffic load and non-zero power signal strength in the cell.
